(19) United States
(12) Patent Application Publication
(10) Pub. No.: US 2025/0105302 A1
(43) Pub. Date: Mar. 27, 2025

(54) POWER STORAGE CELL

(71) Applicant: Toyota Jidosha Kabushiki Kaisha, Toyota-shi (JP)

(72) Inventors: Kazuhito KATO, Toyota-shi (JP); Junta Takasu, Nagoya-shi (JP); Atsushi Yamanaka, Nagoya-shi (JP); Masato Ono, Nagoya-shi (JP); Satoshi Moriyama, Nagoya-shi (JP); Kosuke Suzuki, Toyota-shi (JP); Kazuki Sugie, Miyoshi-shi (JP); Kazuya Kumazawa, Nagoya-shi (JP)

(73) Assignee: Toyota Jidosha Kabushiki Kaisha, Toyota-shi (JP)

(21) Appl. No.: 18/761,705

(22) Filed: Jul. 2, 2024

(30) Foreign Application Priority Data
Sep. 27, 2023 (JP) 2023-165208

(51) Int. Cl. H01M 4/66; H01M 4/02; H01M 10/0587; H01M 50/107; H01M 50/119; H01M 50/152; H01M 50/562

(52) U.S. Cl. CPC H01M 4/662; H01M 10/0587; H01M 50/107; H01M 50/119; H01M 50/152; H01M 50/562; H01M 2004/028

(57) ABSTRACT

A power storage cell according to the present disclosure includes a wound electrode body and a cell case. The wound electrode body includes a cathode and an anode. The cell case accommodates the wound electrode body. The cell case includes a case body and a lid. The case body opens in one direction. The lid closes the case body. The lid includes a cathode external terminal, an anode external terminal, and an insulating member. The cathode external terminal is directly joined to the case body. The anode external terminal is electrically connected to the anode. The insulating member electrically insulates the cathode external terminal and the anode external terminal. The cathode external terminal is electrically connected to the cathode via the case body.

### CROSS-REFERENCE TO RELATED APPLICATION

This application claims priority to Japanese Patent Application No. 2023-165208 filed on Sep. 27, 2023, incorporated herein by reference in its entirety.

### BACKGROUND

### 1. Technical Field

The present disclosure relates to a power storage cell.

### 2. Description of Related Art

Japanese Patent No. 3322321 discloses a conventional non-aqueous electrolyte secondary battery as a power storage cell. In this non-aqueous electrolyte secondary battery, an anode and a cathode are wound with a porous separator interposed therebetween, and inserted into a cylindrical container. Leads extend out from the cathode and the anode. The cylindrical container is made of stainless steel. A container lid is welded to an opening of the container, at a periphery thereof. A cathode terminal and an anode terminal are provided at a part of the container lid.

### SUMMARY

When both the cathode terminal and the anode terminal are provided on the lid, as in the power storage cell disclosed in Japanese Patent No. 3322321, the distance between the cathode lead and the anode lead in the container is relatively short. As a result, the leads may come into contact with each other and be short-circuited.

The present disclosure has been made in view of the above problem, and an object thereof is to provide a power storage cell capable of suppressing short-circuiting inside a cell case.

A power storage cell according to the present disclosure includes a wound electrode body and a cell case. The wound electrode body includes a cathode and an anode. The cell case accommodates the wound electrode body. The cell case includes a case body and a lid. The case body opens in one direction. The lid closes the case body. The lid includes a cathode external terminal, an anode external terminal, and an insulating member. The cathode external terminal is directly joined to the case body. The anode external terminal is electrically connected to the anode. The insulating member electrically insulates the cathode external terminal and the anode external terminal. The cathode external terminal is electrically connected to the cathode via the case body.

According to the above configuration, the need to provide a cathode current collector member such as a tab lead between the wound electrode body and the lid can be done away with. Accordingly, the cathode current collector member does not come into contact with a negatively-charged member between the wound electrode body and the lid. Consequently, short-circuiting inside the cell case can be suppressed.

According to the present disclosure, short-circuiting inside the cell case can be suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a cross-sectional view illustrating a power storage cell according to a first embodiment;

FIG. 2 is a perspective view of the wound electrode body partially exploded;

FIG. 3 is an exploded perspective view partially showing a power storage cell according to the first embodiment;

FIG. 4 is another exploded perspective view partially showing a power storage cell according to the first embodiment;

FIG. 5 is a cross-sectional view showing a power storage cell according to a second embodiment; and

FIG. 6 is an exploded perspective view partially showing a power storage cell according to the second embodiment.

### DETAILED DESCRIPTION OF EMBODIMENTS

Hereinafter, a power storage cell according to each embodiment of the present disclosure will be described with reference to the drawings. The same or corresponding parts in the drawings are denoted by the same reference numerals, and the description thereof will not be repeated.

### First Embodiment

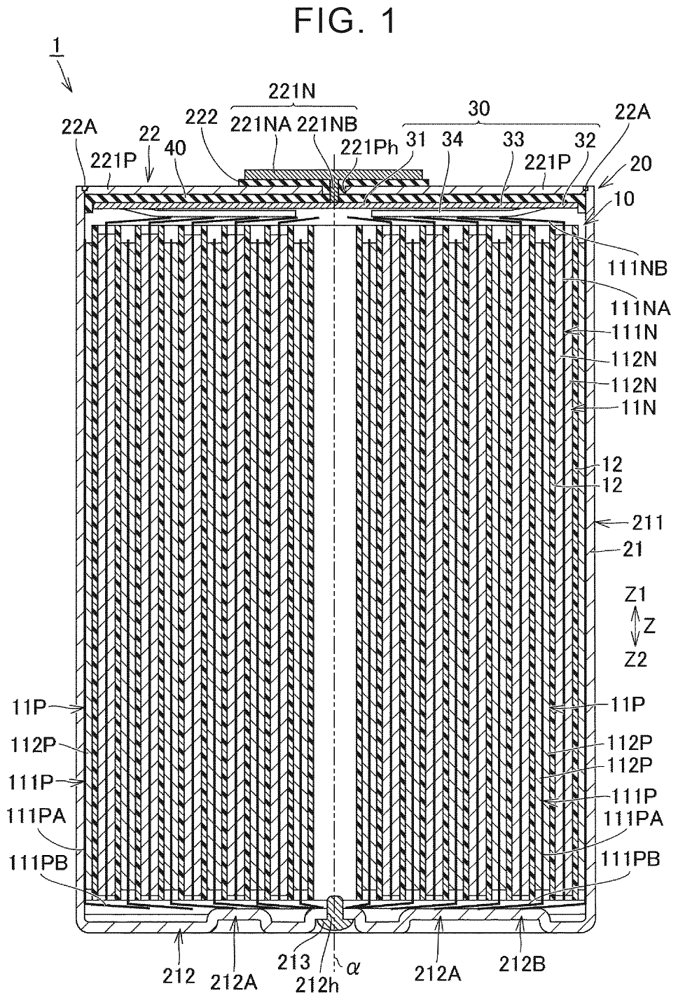

FIG. 1 is a cross-sectional view illustrating a power storage cell according to a first embodiment. As illustrated in FIG. 1, a power storage cell 1 according to the first embodiment of the present disclosure includes a wound electrode body 10, a cell case 20, an anode current collector member 30, and an inner gasket 40.

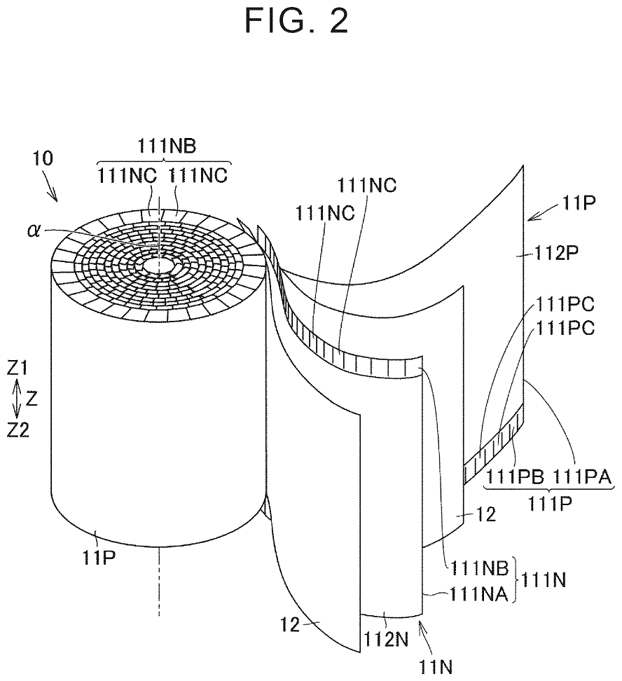

First, the wound electrode body 10 will be described. FIG. 2 is a partially exploded perspective view of the wound electrode body. As shown in FIGS. 1 and 2, the wound electrode body 10 is wound so as to have a cylindrical shape. FIG. 2 illustrates a state in which the winding of the wound electrode body 10 is slightly unwound.

The wound electrode body 10 includes a cathode 11P, an anode 11N, and a separator 12. The cathode 11P and the anode 11N have a sheet-like outer shape. The wound electrode body 10 includes an electrode plate group in which a cathode 11P and an anode 11N are wound with the separator 12 interposed therebetween.

The separator 12 is provided between the cathode 11P and the anode 11N. The separator 12 separates the cathode 11P and the anode 11N while allowing ions (e.g., lithium ions) to move back and forth between the cathode 11P (cathode active material) and the anode 11N (anode active material).

The cathode 11P includes a cathode current collector foil 111P and a cathode composite material layer 112P. The cathode current collector foil 111P is formed of aluminum or an aluminum alloy.

The cathode composite material layers 112P are laminated on the cathode current collector foil 111P. Specifically, the cathode composite material layers 112P are coated on both radial surfaces of a cathode current collector foil 111P (a cathode coating portion 111PA described later). The cathode composite material layers 112P are in close contact with the separator 12. In the present embodiment, the outer surface of the wound electrode body 10 is formed of a cathode 11P. Specifically, the outer surface of the wound electrode body 10 is formed of a cathode current collector foil 111P. That is, the cathode composite material layers 112P are not laminated on the outer surfaces of the cathode current collector foil 111P located on the outermost side in the radial direction of the wound electrode body 10.

The cathode composite material layers 112P are formed by coating a cathode slurry on the cathode current collector foil 111P and drying the cathode slurry. The cathode slurry is a slurry prepared by kneading a material (a cathode active material, a binder, or the like) on 112P of the cathode composite material layers and solvents. The thickness of the cathode composite material layer 112P is, for example, 0.1 μm or more and 1000 μm or less.

The cathode current collector foil 111P includes a cathode coated portion 111PA and a cathode uncoated portion 111PB. The cathode coating portion 111PA is a portion of the cathode current collector foil 111P on which the cathode composite material layer 112P is coated. In other words, the cathode coating portion 111PA is a portion that is not exposed by being covered with the cathode composite material layer 112P.

The cathode uncoated portion 111PB is a portion of the cathode current collector foil 111P that is not covered with the cathode composite material layers 112P and is exposed. The cathode uncoated portion 111PB is located closer to the second direction Z2 than the cathode coated portion 111PA. The second direction Z2 is opposite the first direction Z1 along the axial direction Z. Specifically, the cathode uncoated portion 111PB protrudes from the cathode coated portion 111PA toward the second direction Z2. The cathode uncoated portion 111PB is bent radially inward about the winding axial line α.

The cathode uncoated portion 111PB includes a plurality of extending portions 111PC. The plurality of extending portions 111PC are arranged along the winding direction of the wound electrode body 10.

The anode 11N includes an anode current collector foil 111N and an anode composite material 112N. The anode current collector foil 111N has a sheet-like outer shape. The anode current collector foil 111N is made of, for example, copper.

The anode composite material layers 112N are laminated on the anode current collector foil 111N. Specifically, the anode composite material layers 112N are coated on both radial surfaces of the anode current collector foil 111N (an anode coating portion 111NA described later). The anode composite material layers 112N are in close contact with the separator 12. The anode composite material layers 112N are formed by coating the anode slurry on the anode current collector foil 111N and drying the anode slurry. The anode slurry is a slurry prepared by kneading a material (an anode active material, a binder, or the like) on 112N of the anode composite material layers and solvents. The thickness of the anode composite material 112N is, for example, 0.1 μm or more and 1000 μm or less.

The anode current collector foil 111N includes an anode coating portion 111NA and an anode uncoated portion 111NB. The anode coating portion 111NA is a portion of the anode current collector foil 111N on which the anode composite material layer 112N is coated. In other words, the anode coating portion 111NA is a portion that is not exposed by being covered with the anode composite material layer 112N.

The anode uncoated portion 111NB is a portion where the anode composite material layer 112N is not coated. In other words, the anode uncoated portion 111NB is a portion of the anode current collector foil 111N that is not covered with the anode composite material layers 112N and is exposed. The anode uncoated portion 111NB is located on the first direction Z1 side along the axial direction with respect to the anode coated portion 111NA. The anode uncoated portion 111NB protrudes from the anode coated portion 111NA toward one side in the axial direction Z of the wound electrode body 10. Specifically, the anode uncoated portion 111NB protrudes from the anode coated portion 111NA toward the first direction Z1 along the axial direction Z. The anode uncoated portion 111NB is bent radially inward about the winding axial line α.

The anode uncoated portion 111NB includes a plurality of extending portions 111NC. The plurality of extending portions 111NC are arranged along the winding direction of the wound electrode body 10.

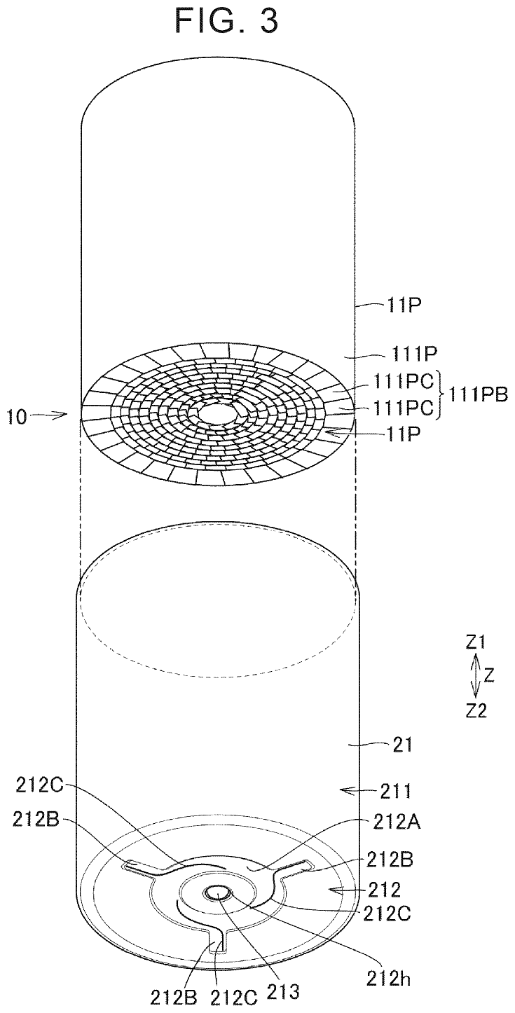

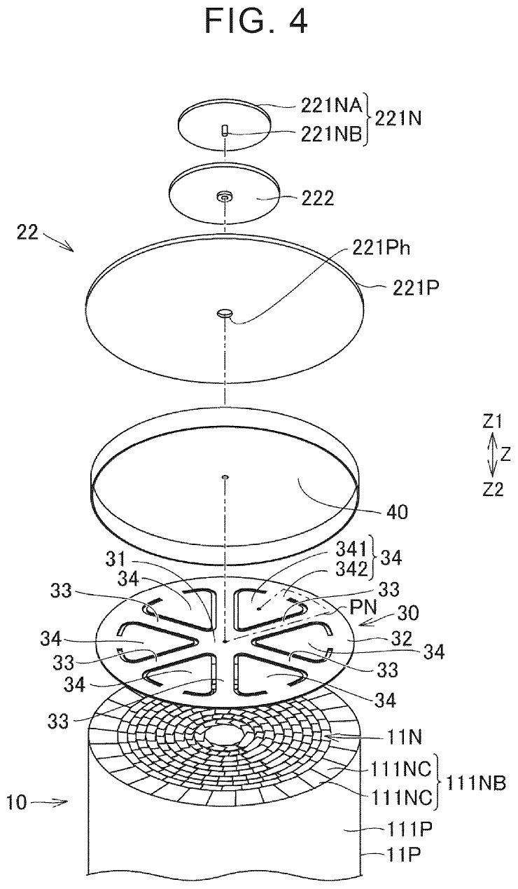

Next, the cell case 20 will be described. FIG. 3 is an exploded perspective view partially showing a power storage cell according to the first embodiment. FIG. 4 is another exploded perspective view partially showing a power storage cell according to the first embodiment. As illustrated in FIGS. 1, 3, and 4, the cell case 20 accommodates the wound electrode body 10. The cell case 20 includes a case body 21 and a lid 22.

The case body 21 opens in one direction. Specifically, the case body 21 opens toward the first direction Z1. The case body 21 has a bottomed cylindrical outer shape. The case body 21 is formed of aluminum or an aluminum alloy.

The case body 21 is directly bonded to the cathode current collector foil 111P. Specifically, the case body 21 is joined to the cathode uncoated portion 111PB (the plurality of extension portions 111NC) by welding. On the second direction Z2 of the wound electrode body 10, the case body 21 is directly bonded to the cathode current collector foil 111P.

The case body 21 includes a cylindrical wall portion 211 and a bottom portion 212. The cylindrical wall portion 211 is provided so as to cover the outer peripheral side of the wound electrode body 10. The cylindrical wall portion 211 covers the entire outer peripheral side of the wound electrode body 10. The cylindrical wall portion 211 has a cylindrical shape. The cylindrical wall portion 211 may have a rectangular cylindrical outer shape. The inner circumferential surface of the cylindrical wall portion 211 is in close contact with the cathode 11P constituting the radially outer surface of the wound electrode body 10. Specifically, the inner peripheral surface of the cylindrical wall portion 211 is in contact with the cathode current collector foil 111P. However, the inner peripheral surface of the cylindrical wall portion 211 may be in contact with the cathode composite material layers 112P. The inner peripheral surface of the cylindrical wall portion 211 may be in contact with the separator 12.

The bottom portion 212 is disposed on one side in the axial direction Z as viewed from the wound electrode body 10. Specifically, the bottom portion 212 is disposed on the second direction Z2 side along the axial direction Z when viewed from the wound electrode body 10. The bottom portion 212 is connected to the second direction Z2 end of the cylindrical wall portion 211. In the present embodiment, the bottom portion 212 is integrally formed with the cylindrical wall portion 211. The bottom portion 212 may be molded as a separate member from the cylindrical wall portion 211. At this time, the outer peripheral edge of the bottom portion 212 may be joined to the cylindrical wall portion 211 by laser welding or the like. The bottom portion 212 is electrically connected to the cylindrical wall portion 211.

The bottom portion 212 is joined to the cathode uncoated portion 111PB by welding from the outer side of the cell case 20. As a result, the bottom portion 212 is positively charged. The cylindrical wall portion 211 connected to the bottom portion 212 is also positively charged. Note that the bottom portion 212 of the power storage cell 1 may be used as a cathode terminal.

The bottom portion 212 includes a ring-shaped ridge portion 212A, a plurality of radial ridge portions 212B, and a plurality of weld portions 212C. The annular ridge 212A extends annularly around the winding axis a of the wound electrode body 10 when viewed from the axial direction Z. The ring-shaped ridge 212A protrudes toward the first direction Z1. That is, the ring-shaped ridge portion 212A protrudes toward the wound electrode body 10. The ring-shaped ridge portion 212A is in contact with the cathode uncoated portion 111PB of the cathode 11P.

The plurality of radial ridge portions 212B are arranged so as to be spaced apart from each other in the circumferential direction around the winding axis a of the wound electrode body 10 when viewed in the axial direction Z. The plurality of radial ridge portions 212B are arranged at equal intervals in the circumferential direction.

Each of the plurality of radial ridge portions 212B extends in the radial direction around the winding-axis line α of the wound electrode body 10. The radial ridge portion 212B is continuous with the annular ridge portion 212A.

The radial ridge 212B protrudes toward the first direction Z1. That is, the radial ridge portion 212B protrudes toward the wound electrode body 10. The radial ridge portion 212B is in contact with the cathode uncoated portion 111PB of the cathode 11P.

The plurality of weld portions 212C are portions of the bottom portion 212 that are joined to the cathode uncoated portion 111PB by welding. The plurality of weld portions 212C are formed by laser-welding or the like from the outer side of the cell case 20. The plurality of weld portions 212C are formed in the ring-shaped ridge portion 212A. In the ring-shaped ridge portion 212A, the plurality of weld portions 212C are formed so as to extend along the circumferential direction. The plurality of weld portions 212C are formed in each of the plurality of radial ridge portions 212B. In the radial ridge portion 212B, the weld portion 212C is formed so as to extend along the radial direction. The annular ridge portion 212A and the plurality of radial ridge portions 212B may be thinner than other portions of the bottom portion 212. Thus, the welded portion 212C can be easily formed.

A through-hole 212h is formed in the bottom portion 212. The through-hole 212h may be used to inject an electrolyte (not shown) accommodated in the cell case 20. The through-hole 212h is formed in the center of the bottom portion 212 when viewed from the axial direction Z.

The sealing plug 213 is inserted through the through-hole 212h of the bottom portion 212. As a result, the sealing plug 213 is fixed to the bottom portion 212. The sealing plug 213 and the through-hole 212h may function as a pressure release valve for releasing the pressure inside the cell case 20 when the pressure inside the cell case 20 becomes excessively high.

The lid 22 closes the case body 21. The lid 22 includes a cathode external terminal 221P, an anode external terminal 221N, and an insulating member 222.

The cathode external terminal 221P has a plate-like outer shape. Specifically, the cathode external terminal 221P has a substantially disk-shaped outer shape.

The cathode external terminal 221P is provided so as to be perpendicular to the axial direction Z. The cathode external terminal 221P is provided with a through-hole 221Ph. Therefore, the cathode external terminal 221P has a ring-shaped outer shape when viewed from the axial direction Z. The cathode external terminal 221P is formed of aluminum or an aluminum alloy.

The cathode external terminal 221P is directly joined to the case body 21 (cylindrical wall portion 211). As a result, the cathode external terminal 221P connected to the case body 21 (the cylindrical wall portion 211) is also positively charged. Therefore, in the present embodiment, the cathode external terminal 221P is electrically connected to the cathode 11P via the case body 21. The cathode external terminal 221P may be joined to the cylindrical wall portion 211 by crimping an end portion of the cylindrical wall portion 211.

The cathode external terminal 221P is joined to the first direction Z1 end of the case body 21 (cylindrical wall portion 211) by welding such as laser-welding. As a result, a ring-shaped welded portion 22A is formed between the cylindrical wall portion 211 and the cathode external terminal 221P.

The anode external terminal 221N is electrically connected to the anode 11N via an anode current collector member 30, which will be described later. The anode external terminal 221N is made of, for example, aluminum, copper, or stainless steel.

The anode external terminal 221N is disposed on the first direction Z1 side of the wound electrode body 10. The anode external terminal 221N includes a disc portion 221NA and a rivet portion 221NB.

The disc portion 221NA is exposed to the outside. The disc portion 221NA is positioned opposite to the wound electrode body 10 when viewed from the cathode external terminal 221P.

The rivet portion 221NB is connected to the disc portion 221NA. The rivet portion 221NB extends from the center of the disc portion 221NA when viewed from the axial direction Z. The rivet portion 221NB is located approximately on the winding axis a of the wound electrode body 10. The rivet portion 221NB extends to the second direction Z2 side when viewed from the disc portion 221NA. The rivet portion 221NB is inserted through the through-hole 221Ph. The rivet portion 221NB extends to the inside of the cell case 20.

The insulating member 222 electrically insulates the cathode external terminal 221P from the anode external terminal 221N. The insulating member 222 is disposed between the cathode external terminal 221P and the anode external terminal 221N. The insulating member 222 covers the second direction Z2 side surface of the disc portion 221NA. The rivet portion 221NB penetrates the insulating member 222 in the axial direction Z. The insulating member 222 covers the radially inner surface of the through hole 221Ph of the cathode external terminal 221P.

Next, the anode current collector member 30 will be described. As shown in FIGS. 1 and 4, the anode current collector member 30 is disposed in the cell case 20. The anode current collector member 30 is disposed on the first direction Z1 side of the wound electrode body 10. In the present embodiment, the anode current collector member 30 has a plate-like outer shape, but may be a tab-like lead.

The anode current collector member 30 is provided to electrically connect the anode 11N and the anode external terminal 221N. The anode current collector member 30 is welded to the anode uncoated portion 111NB of the anode 11N. As a result, the anode current collector member 30 is negatively charged. The anode current collector member 30 is welded to an end portion on the second direction Z2 side of the rivet portion 221NB of the anode external terminal 221N. As a result, the anode external terminal 221N is negatively charged.

The anode current collector member 30 has a substantially disk-shaped outer shape. The anode current collector member 30 includes a central portion 31, an outer peripheral edge portion 32, a plurality of spokes 33, and a plurality of piece portions 34.

The central portion 31 is positioned so as to overlap with the rivet portion 221NB of the anode external terminal 221N when viewed from the axial direction Z. The central portion 31 is welded to the rivet portion 221NB of the anode external terminal 221N.

The outer peripheral edge portion 32 is provided on the outer peripheral edge of the anode current collector member 30. The outer peripheral edge portion 32 is located on the outer peripheral side of the central portion 31. The outer peripheral edge portion 32 extends in an annular shape around the central portion 31. The outer peripheral edge portion 32 may be in contact with the anode uncoated portion 111NB of the anode 11N. However, the outer peripheral edge portion 32 is not bonded to the anode uncoated portion 111NB.

The plurality of spokes 33 are spaced apart from each other. The plurality of spokes 33 are arranged at equal intervals in the circumferential direction around the central portion 31. The spoke 33 connects the central portion 31 and the outer peripheral edge portion 32. The spoke 33 has an outer shape such that a width dimension thereof is substantially equal from the central portion 31 to the outer peripheral edge portion 32.

The plurality of piece portions 34 are spaced apart from each other. The plurality of piece portions 34 are arranged at equal intervals in the circumferential direction around the central portion 31. The plurality of spokes 33 and the plurality of piece portions 34 are arranged such that the spokes 33 and the piece portions 34 are alternately arranged in the circumferential direction around the central portion 31.

The piece portion 34 extends from the outer peripheral edge portion 32 toward the central portion 31. The piece portion 34 is connected to the anode 11N. Specifically, the piece portion 34 is welded to the anode uncoated portion 111NB of the anode 11N. In FIG. 4, the path PN on the anode current collector member 30 from the joint portion between the piece portion 34 and the anode uncoated portion 111NB to the joint portion between the central portion 31 and the rivet portion 221NB is schematically illustrated.

The piece portion 34 includes a fan-shaped portion 341 and a neck portion 342. The fan-shaped portion 341 is welded to the anode uncoated portion 111NB of the anode 11N. The tip of the fan-shaped portion 341 faces the central portion 31. The fan-shaped portion 341 extends toward the outer peripheral edge portion 32 along two adjacent spokes 33 on both sides in the circumferential direction. As a result, the surface area of the fan-shaped portion 341 becomes relatively large, and the anode 11N can be easily welded to the uncoated portion 111NB of the anode.

The neck portion 342 connects the outer peripheral edge portion 32 and the fan-shaped portion 341. The neck portion 342 may be in contact with the anode uncoated portion 111NB of the anode 11N. However, the neck portion 342 is not bonded to the anode uncoated portion 111NB of the anode 11N. The dimension of the neck portion 342 in the circumferential direction is smaller than the dimension of the outer peripheral edge of the fan-shaped portion 341 in the circumferential direction. This facilitates bending of the piece portion 34 in the neck portion 342.

Here, an exemplary process of welding the central portion 31 and the rivet portion 221NB in the present embodiment will be described. First, prior to the central portion 31 being welded to the rivet portion 221NB, the fan-shaped portion 341 of the piece portion 34 is previously welded to the anode uncoated portion 111NB of the anode 11N. Next, the welder is inserted along the winding axis a of the wound electrode body 10 from the second direction Z2 side of the wound electrode body 10. Then, while the welding device is pressed against the central portion 31 from the second direction Z2 side, the central portion 31 and the rivet portion 221NB are welded to each other by the welding device. At this time, on the path PN, the connecting portion between the spoke 33 and the central portion 31 and the connecting portion between the spoke 33 and the outer peripheral edge portion 32 are greatly bent. As a result, the central portion 31 can be easily displaced in the axial direction Z relative to the piece portion 34. Therefore, even if the welder is pressed against the central portion 31, the joint between the piece portion 34 and the anode uncoated portion 111NB is prevented from being broken due to the displacement of the central portion 31. As a result, the anode current collector member 30 and the anode external terminal 221N can be easily connected to each other.

The inner gasket 40 is accommodated in the cell case 20. The inner gasket 40 covers the surface of the cathode external terminal 221P that is on the second direction Z2 side. The inner gasket 40 is formed of an insulating material. Therefore, the inner gasket 40 insulates the wound electrode body 10 from the cathode external terminal 221P. The rivet portion 221NB passes through the inner gasket 40 in the axial direction Z.

Specifically, the inner gasket 40 is disposed between the anode current collector member 30 and the cathode external terminal 221P. As a result, the anode current collector member 30 and the cathode external terminal 221P are electrically insulated from each other. Further, the inner gasket 40 extends to the outer peripheral side of the anode current collector member 30. As a result, the inner gasket 40 is also disposed between the anode current collector member 30 and the cylindrical wall portion 211. Therefore, the anode current collector member 30 and the cylindrical wall portion 211 are electrically insulated from each other.

As described above, the power storage cell 1 according to the first embodiment of the present disclosure includes the wound electrode body 10 and the cell case 20. The wound electrode body 10 includes a cathode 11P and an anode 11N. The cell case 20 accommodates the wound electrode body 10. The cell case 20 includes a case body 21 and a lid 22. The case body 21 opens in one direction. The lid 22 closes the case body 21. The lid 22 includes a cathode external terminal 221P, an anode external terminal 221N, and an insulating member 222. The cathode external terminal 221P is directly bonded to the case body 21. The anode external terminal 221N is electrically connected to the anode 11N. The insulating member 222 electrically insulates the cathode external terminal 221P from the anode external terminal 221N. The cathode external terminal 221P is electrically connected to the cathode 11P via the case body 21.

According to the above configuration, it is not necessary to provide a cathode current collector member such as a tab lead between the wound electrode body 10 and the lid 22. Therefore, the cathode current collector member does not come into contact with the negatively-charged member between the wound electrode body 10 and the lid 22. As a result, a short circuit inside the cell case 20 can be suppressed.

In the present embodiment, the cathode 11P includes a cathode current collector foil 111P and a cathode composite material layer 112P. The cathode current collector foil 111P is formed of aluminum or an aluminum alloy. The cathode composite material layers 112P are laminated on the cathode current collector foil 111P. The case body 21 is directly bonded to the cathode current collector foil 111P. The case body 21 is formed of aluminum or an aluminum alloy. The cathode external terminal 221P is formed of aluminum or an aluminum alloy.

According to the above configuration, since the case body 21 is directly bonded to the cathode current collector foil 111P, the weight of the case body 21 can be reduced. Since the case body 21 is made of aluminum or an aluminum alloy, the case body 21 can be further reduced in weight. Since both the case body 21 and the cathode current collector foil 111P are formed of aluminum or an aluminum alloy and are directly bonded to each other, the contact-resistance can be reduced. Further, since the cathode external terminal 221P and the case body 21 are made of aluminum or an aluminum alloy, the contact-resistance can be further reduced.

### Second Embodiment

Next, a power storage cell according to a second embodiment of the present disclosure will be described. The power storage cell according to the second embodiment of the present disclosure is different from the first embodiment of the present disclosure in that the power storage cell further includes a cathode current collector member. Therefore, the same configuration and effects as those of the first embodiment of the present disclosure will not be described repeatedly.

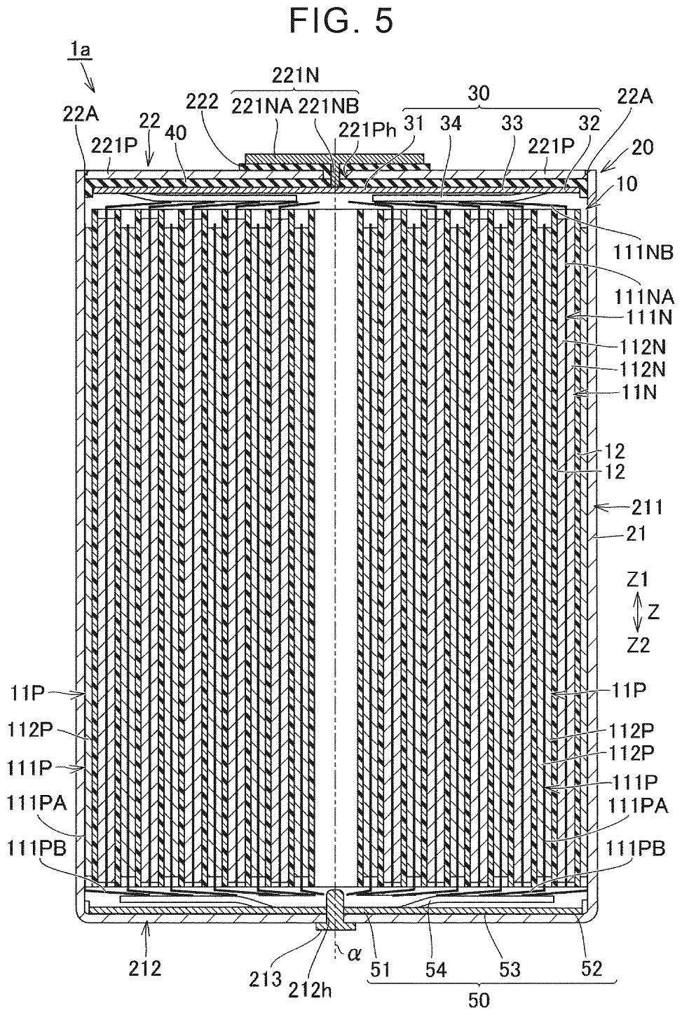

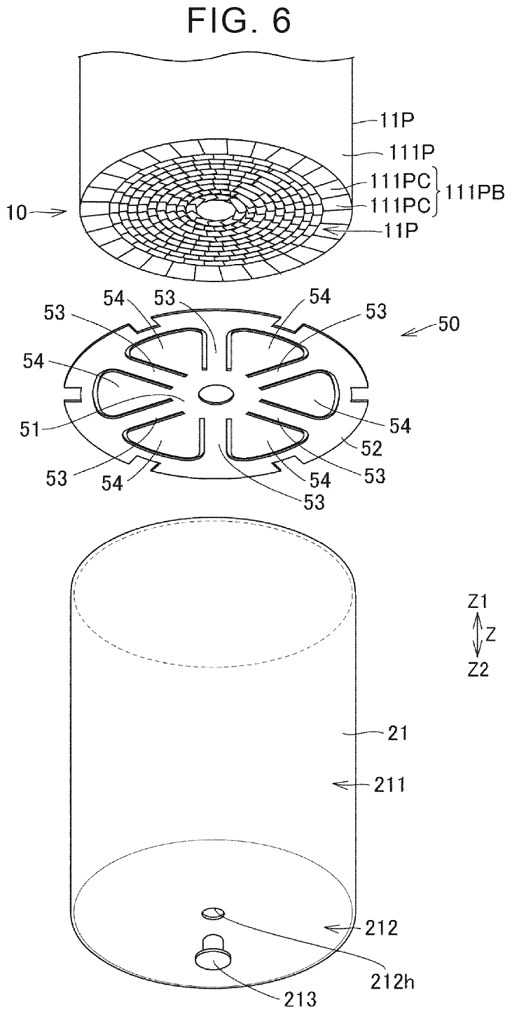

FIG. 5 is a cross-sectional view illustrating a power storage cell according to a second embodiment. FIG. 6 is an exploded perspective view partially showing a power storage cell according to the second embodiment.

As illustrated in FIGS. 5 and 6, the power storage cell la further includes a cathode current collector member 50. The cathode current collector member 50 is disposed between the wound electrode body 10 and the case body 21 on the side opposite to the lid 22 when viewed from the wound electrode body 10. The cathode current collector member 50 is formed of aluminum or an aluminum alloy. The cathode current collector member 50 is directly bonded to the cathode current collector foil 111P. The cathode current collector member 50 is connected to the case body 21.

According to the above-described configuration, the cathode current collector member 50 increases the degree of freedom in the connecting mode between the case body 21 and the cathode 11P while suppressing an internal short circuit between the wound electrode body 10 and the lid 22. The cathode current collector member 50, the cathode current collector foil 111P, and the case body 21 are both formed of aluminum or an aluminum alloy, and they are connected to each other, so that an increase in the contact-resistance can be suppressed.

In the present embodiment, the cathode current collector member 50 has a plate-like outer shape, but may be a tab-like lead. The cathode current collector member 50 is welded to the cathode uncoated portion 111PB of the cathode 11P. As a result, the cathode current collector member 50 is positively charged. The cathode current collector member 50 may or may not be joined to the case body 21 (bottom portion 212) by welding. However, the cathode current collector member 50 is in close contact with the bottom portion 212. As a result, the case body 21 is also positively charged.

Like the anode current collector member 30, the cathode current collector member 50 includes a central portion 51, an outer peripheral edge portion 52, a plurality of spokes 53, and a plurality of piece portions 54. However, in the cathode current collector member 50, each piece portion 54 extends from the central portion 51 toward the outer peripheral edge portion 52. The piece portion 54 is connected to the cathode 11P. Specifically, the piece portion 54 is welded to the cathode uncoated portion 111PB of the cathode 11P.

The embodiments disclosed herein are to be considered in all respects as illustrative and not restrictive. It is intended that the scope of the disclosure be defined by the appended claims rather than the description of the embodiments described above, and that all changes within the meaning and range of equivalency of the claims be embraced therein.

What is claimed is:

1. A power storage cell comprising:
a wound electrode body including a cathode and an anode; and
a cell case for accommodating the wound electrode body, wherein
the cell case includes a case body that opens in one direction, and a lid for closing the case body,
the lid includes a cathode external terminal directly joined to the case body, an anode external terminal electrically connected to the anode, and an insulating member for electrically insulating the cathode external terminal and the anode external terminal, and
the cathode external terminal is electrically connected to the cathode via the case body.

2. The power storage cell according to claim 1, wherein:
the cathode includes a cathode current collector foil and a cathode composite material layer;
the cathode current collector foil is made of aluminum or an aluminum alloy;
the cathode composite material layer is laminated on the cathode current collector foil;
the case body is directly joined to the cathode current collector foil;
the case body is made of aluminum or an aluminum alloy; and
the cathode external terminal is made of aluminum or an aluminum alloy.

3. The power storage cell according to claim 1, further comprising a cathode current collector member disposed between the wound electrode body and the case body on a side opposite to the lid as viewed from the wound electrode body, wherein:
the cathode includes a cathode current collector foil and a cathode composite material layer;
the cathode current collector foil is made of aluminum or an aluminum alloy;
the cathode composite material layer is laminated on the cathode current collector foil;
the cathode current collector member is made of aluminum or an aluminum alloy;
the cathode current collector member is directly joined to the cathode current collector foil;
the cathode current collector member is connected to the case body;
the case body is made of aluminum or an aluminum alloy; and
the cathode external terminal is made of aluminum or an aluminum alloy.
